(19) United States
(12) Patent Application Publication
(10) Pub. No.: US 2023/0042661 A1
(43) Pub. Date: Feb. 9, 2023

(54) First Detection of Potential Harmful Activities

(71) Applicant: Orev Secure Networks LLC, Boca Raton, FL (US)

(72) Inventors: Gabi Saadon, Boca Raton, FL (US); Shmuel Silverman, Novato, CA (US)

(73) Assignee: Orev Secure Networks LLC, Boca Raton, FL (US)

(21) Appl. No.: 17/870,828

(22) Filed: Jul. 22, 2022

Related U.S. Application Data
(60) Provisional application No. 63/228,978, filed on Aug. 3, 2021.

(51) Int. Cl. G06F 21/85; G06F 21/31; G06F 21/54

(52) U.S. Cl. CPC G06F 21/85; G06F 21/31; G06F 21/54

(57) ABSTRACT

Computer-implemented security techniques and a respective system for detecting a computer-system anomaly behavior before, during and/or after operations is described. These network-security may use instances of an agent that resides in every host-monitored computer or electronic device (such as a portable computer or a cellular telephone) and a network-security computer that is associated with an organization, and which is located on premises and/or in the cloud. Notably, the instances of the agent may monitor complicated system behavior and may report first detection of behavioral anomalies to the network-security computer. Then, the network-security computer may perform a remedial action based at least in part on the first detection of the behavioral anomalies.

### CROSS REFERENCE TO RELATED APPLICATIONS

This application claims priority under 35 U.S.C. 119(e) to: U.S. Provisional Application Ser. No. 63/228,978, “First Detection of Potential Harmful Activities,” by Gabi Saadon et al., filed on Aug. 3, 2021, the contents of which are herein incorporated by reference.

### FIELD

The described embodiments relate, generally, to security techniques for detecting anomalous behaviors of host-computer hardware and software.

### BACKGROUND

The hardware and software infrastructure of a typical enterprise is becoming increasingly complicated. This hardware and software infrastructure may include several internal networks, remote offices with their own local infrastructure, remote and/or mobile electronic devices associated with individuals, and/or cloud services. The complexity of the hardware and the software infrastructure often outstrips traditional techniques for perimeter-based network security, because there is no longer a single, easily identified perimeter for the enterprise.

Presently, it takes companies, on average, about 197 days to identify a network-security attack and 69 days to contain the associated breach. The amount of time it takes to detect a breach varies by industry, with entertainment and health care taking upwards of 250 days. There are multiple factors that can impact the data-breach-response time, including: preparation, technology and privacy laws.

There are several existing security techniques for detecting suspicious or malicious activity within a network and associated tools include: an Intrusion Detection System, an Intrusion Prevention System, Data Loss Prevention, Security Incident and Event Management, and Network Behavior Anomaly Detection. Additionally, a company usually installs antivirus or other cybersecurity program on electronic devices associated with the company, including on-site and remote electronic devices. In some cases, users may install two different types of antivirus software for greater protection. However, these anti-virus solutions can only detect known viruses (e.g., based on known signatures of the viruses).

Another existing security technique is based on the use of detection logs through malware protection and detection hardware and/or software with logging capabilities. Typically, companies will hire a cybersecurity profession to review the logs and identify any unusual activity.

The increasing proliferation of network-security attacks and the limitations of existing security techniques are an increasing problem for companies and have adverse consequences for business activity.

### SUMMARY

In a first group of embodiments, an electronic device is described. This electronic device includes: an interface circuit that communicates with a second electronic device and a computer; a processor; and memory that stores program instructions, where, when executed by the computation device, the program instructions cause the electronic device to perform operations. During operation, the electronic device detects a first occurrence of the second electronic device accessing the electronic device using a communication protocol via the interface circuit, where the second electronic device has not previously accessed the electronic device using the communication protocol via the interface circuit. Then, the electronic device provides, addressed to the computer, a notification indicating the first occurrence of access by the second electronic device.

Note that the communication protocol may include universal serial bus (USB).

Moreover, the electronic device may: detect a second occurrence of the second electronic device accessing the electronic device using the communication protocol via the interface circuit, wherein the second occurrence occurs after the first occurrence; and selectively provide, addressed to the computer and based at least in part on a change in a state of the second electronic device, a second notification indicating the second occurrence of access by the second electronic device. Furthermore, the change in the state may include a change in information stored in memory in the second electronic device. Additionally, the change in the state may be relative to a previous state of the second electronic device. In some embodiments, the operations may include determining the previous state of the second electronic device during the first occurrence of access by the second electronic device.

Other embodiments provide the second electronic device or the computer, which perform counterpart operations to the aforementioned operations of the electronic device.

Other embodiments provide a computer-readable storage medium for use with the electronic device, the second electronic device or the computer. When program instructions stored in the computer-readable storage medium are executed by the electronic device, the second electronic device or the computer, the program instructions may cause the electronic device, the second electronic device or the computer to perform at least some of the aforementioned operations of the electronic device or counterpart operations to the aforementioned operations.

Other embodiments provide a method. The method includes at least some of the aforementioned operations performed by the electronic device, or counterpart operations to the aforementioned operations, which are performed by the second electronic device or the computer.

In a second group of embodiments, an electronic device is described. This electronic device includes: an interface circuit that communicates with a second electronic device and a computer; a processor; and memory that stores program instructions, where, when executed by the computation device, the program instructions cause the electronic device to perform operations. During operation, the electronic device detects a first occurrence of the second electronic device accessing the electronic device, where the second electronic device has a second memory that is separate from the memory. Then, the electronic device provides, addressed to the computer, a notification indicating the first occurrence of access by the second electronic device.

Moreover, the electronic device may: detect a second occurrence of the second electronic device accessing the electronic device, where the second occurrence occurs after the first occurrence; and selectively provide, addressed to the computer and based at least in part on a change in a state of the second memory, a second notification indicating the second occurrence of access by the second electronic device. Furthermore, the change in the state may include a change in information stored in the second memory. Additionally, the change in the state may be relative to a previous state of the second memory. In some embodiments, the electronic device may determine the previous state of the second memory during the first occurrence of access by the second electronic device.

Other embodiments provide the second electronic device or the computer, which perform counterpart operations to the aforementioned operations of the electronic device.

Other embodiments provide a computer-readable storage medium for use with the electronic device, the second electronic device or the computer. When program instructions stored in the computer-readable storage medium are executed by the electronic device, the second electronic device or the computer, the program instructions may cause the electronic device, the second electronic device or the computer to perform at least some of the aforementioned operations of the electronic device or counterpart operations to the aforementioned operations.

Other embodiments provide a method. The method includes at least some of the aforementioned operations performed by the electronic device, or counterpart operations to the aforementioned operations, which are performed by the second electronic device or the computer.

In a third group of embodiments, an electronic device is described. This electronic device includes: an interface circuit that communicates with a computer; a processor; and memory that stores program instructions, where, when executed by the computation device, the program instructions cause the electronic device to perform operations. During operation, the electronic device determines a change to an operating system or a BIOS driver of the electronic device while the program instructions were deactivated or were not executed by the processor. Then, the electronic device detects a second change to information, stored in the memory, that corresponds to a runtime of the electronic device. Next, the electronic device selectively provides, addressed to the computer and based at least in part on the determined change and the detected second change, a notification indicating the determined change and the detected second change.

Moreover, the electronic device may compute whether or not the determined change is legitimate, where the selective providing occurs when the determined change is not legitimate. Furthermore, the computing may be based at least in part on one or more of: a digital signature associated with the operating system or the BIOS driver; a value associated with the operating system or the BIOS driver that is generated using a cryptographic hash function; or both. Additionally, the cryptographic hash function may include: MD5, or SH-1.

Other embodiments provide the computer, which perform counterpart operations to the aforementioned operations of the electronic device.

Other embodiments provide a computer-readable storage medium for use with the electronic device or the computer. When program instructions stored in the computer-readable storage medium are executed by the electronic device or the computer, the program instructions may cause the electronic device or the computer to perform at least some of the aforementioned operations of the electronic device or counterpart operations to the aforementioned operations.

Other embodiments provide a method. The method includes at least some of the aforementioned operations performed by the electronic device, or counterpart operations to the aforementioned operations, which are performed by the computer.

In a fourth group of embodiments, an electronic device is described. This electronic device includes: an interface circuit that communicates with a computer; a processor; and memory that stores program instructions, where, when executed by the computation device, the program instructions cause the electronic device to perform operations. During operation, the electronic device detects a change to information stored at a set of locations in the memory. Then, the electronic device provides, addressed to the computer and based at least in part on the detected change, a notification indicating the determined change.

Note that the set of locations may include: randomly selected addresses; and/or locations in a subset of addresses in the memory.

Moreover, the electronic device may, prior to the detecting, determine a prior instance of the information, where the detecting is based at least in part on the predetermined prior instance of the information.

Furthermore, the electronic device may update the determined prior instance of the information following a write operation to at least a location in the set of locations in the memory.

Other embodiments provide the computer, which perform counterpart operations to the aforementioned operations of the electronic device.

Other embodiments provide a computer-readable storage medium for use with the electronic device or the computer. When program instructions stored in the computer-readable storage medium are executed by the electronic device or the computer, the program instructions may cause the electronic device or the computer to perform at least some of the aforementioned operations of the electronic device or counterpart operations to the aforementioned operations.

Other embodiments provide a method. The method includes at least some of the aforementioned operations performed by the electronic device, or counterpart operations to the aforementioned operations, which are performed by the computer.

In a fifth group of embodiments, an electronic device is described. This electronic device includes: an interface circuit that communicates with a computer; a processor; and memory that stores program instructions, where, when executed by the computation device, the program instructions cause the electronic device to perform operations. During operation, the electronic device detects a difference between information computed based at least in part associated with a dynamic-link library (DLL) stored in the memory and predetermined information associated with the DLL. Then, the electronic device provides, addressed to the computer and based at least in part on the detected difference, a notification indicating the determined difference.

Note that the information and the predetermined information may correspond to a first cryptographic hash function and a second cryptographic hash function. For example, the first cryptographic hash function may include MD5 and the second cryptographic hash function may include SH-1.

Moreover, the DLL may include multiple modules or library functions, and the information and the predetermined information may correspond to each of the modules or library functions. Furthermore, the information and the predetermined information may correspond to functions of the DLL.

Other embodiments provide the computer, which perform counterpart operations to the aforementioned operations of the electronic device.

Other embodiments provide a computer-readable storage medium for use with the electronic device or the computer. When program instructions stored in the computer-readable storage medium are executed by the electronic device or the computer, the program instructions may cause the electronic device or the computer to perform at least some of the aforementioned operations of the electronic device or counterpart operations to the aforementioned operations.

Other embodiments provide a method. The method includes at least some of the aforementioned operations performed by the electronic device, or counterpart operations to the aforementioned operations, which are performed by the computer.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an example of communication between electronic devices according to some embodiments of the disclosure.

FIG. 2 is a flow diagram illustrating an example of a method for providing a notification using an electronic device in FIG. 1 in accordance with an embodiment of the present disclosure.

FIG. 3 is a drawing illustrating an example of communication among an electronic device and a computer system in FIG. 1 in accordance with an embodiment of the present disclosure.

FIG. 4 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

During operation, an electronic device may detect a first occurrence of: a second electronic device accessing the electronic device, e.g., using: a communication protocol (such as USB) via an interface circuit, where the second electronic device has not previously accessed the electronic device using the communication protocol via the interface circuit. Alternatively or additionally, the electronic device may: detect a change to an operating system or a BIOS driver of the electronic device while program instructions were deactivated or were not executed by a processor in the electronic device, and subsequent second change to stored information that corresponds to the runtime of the electronic device; detect a change to stored information; and/or detect a difference between information computed based at least in part associated with a stored DLL and predetermined information associated with the DLL. Then, the electronic device may provide, addressed to a computer, a notification indicating: the first occurrence, the detected change and/or the detected second change, or the detected difference.

By performing first detection and/or detecting the change(s), these security techniques may more rapidly and accurately detect intrusions and malicious events in a computer system. These capabilities may enable effective and timely remedial action with reduced or eliminated false-positive detections, thereby reducing or eliminating the security risk and harm associated with the intrusions and malicious events. Moreover, by combining distributed agents with centralized aggregation or collection of information, the security techniques may readily scale to large computer systems in a cost-effective and less-complicated manner. Consequently, the security techniques may improve security, the security techniques may improve user satisfaction and may enhance business activity and trust.

In the discussion that follows, electronic devices, computers and/or servers (which may be local or remotely located from each other) may communicate packets or frames in accordance with a wired communication protocol and/or a wireless communication protocol. The wireless communication protocol may include: a wireless communication protocol that is compatible with an Institute of Electrical and Electronics Engineers (IEEE) 802.11 standard (which is sometimes referred to as ‘Wi-Fi®,’ from the Wi-Fi Alliance of Austin, Tex.), Bluetooth, Bluetooth low energy, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, the wired communication protocol may include a wired communication protocol that is compatible with an IEEE 802.3 standard (which is sometimes referred to as ‘Ethernet’), e.g., an Ethernet II standard. However, a wide variety of communication protocols may be used. In the discussion that follows, Wi-Fi and Ethernet are used as illustrative examples.

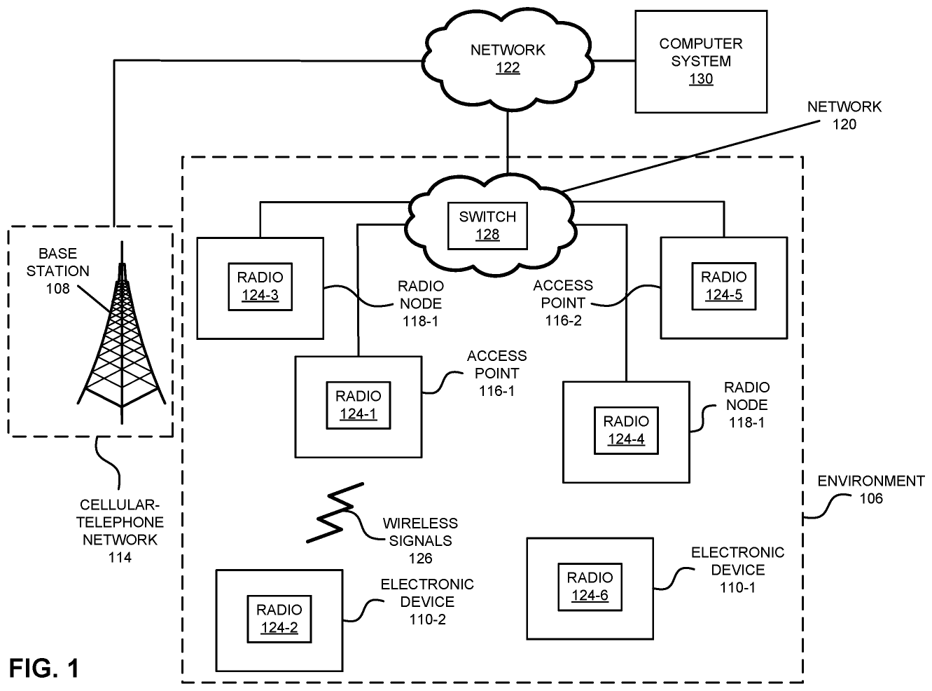

We now describe some embodiments of the security techniques. FIG. 1 presents a block diagram illustrating an example of communication between electronic devices 110 (such as a cellular telephone, a portable electronic device, or another type of electronic device, etc.) in an environment 106. Moreover, electronic devices 110 may optionally communicate via a cellular-telephone network 114 (which may include a base station 108), one or more access points 116 (which may communicate using Wi-Fi) in a wireless local area network (WLAN) and/or radio node 118 (which may communicate using LTE or a cellular-telephone data communication protocol) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic devices 110 may optionally communicate with computer system 130 (which may include one or more computers or servers, and which may be implemented locally or remotely to provide storage and/or analysis services) using a wired communication protocol (such as Ethernet) via network 120 and/or 122. Note that networks 120 and 122 may be the same or different networks. For example, networks 120 and/or 122 may be a LAN, an intra-net or the Internet. In some embodiments, the wired communication protocol may include a secured connection over transmission control protocol/Internet protocol (TCP/IP) using hypertext transfer protocol secure (HTTPS). Additionally, in some embodiments, network 120 may include one or more routers and/or switches (such as switch 128).

Electronic devices 110 and/or computer system 130 may implement at least some of the operations in the security techniques. Notably, as described further below, a given one of electronic devices (such as electronic device 110-1) and/or computer system 130 may perform at least some of the analysis of data associated with electronic device 110-1 (such as first detection of a new peripheral, communication via an interface, a change to software or program instructions, a change to a DLL, a change to stored information, etc.) acquired by an agent executing in an environment (such as an operating system) of electronic device 110-1, and may provide data and/or first-detection information to computer system 130.

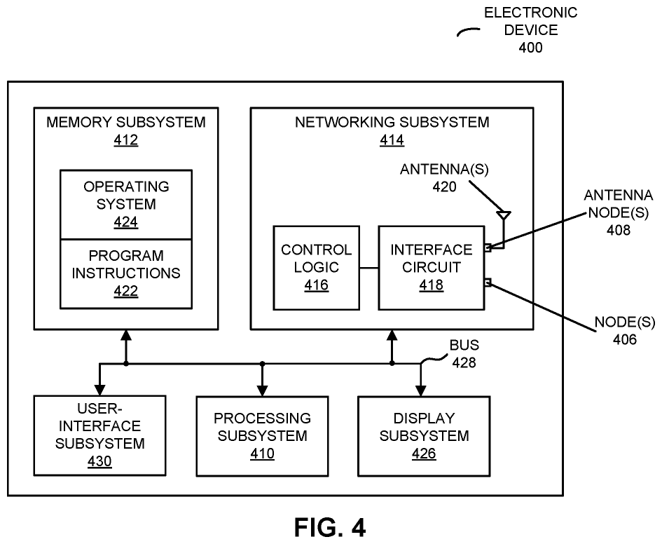

As described further below with reference to FIG. 4, base station 108, electronic devices 110, access points 116, radio node 118, switch 128 and/or computer system 130 may include subsystems, such as a networking subsystem, a memory subsystem and a processor subsystem. In addition, electronic devices 110, access points 116 and radio node 118 may include radios 124 in the networking subsystems. More generally, electronic devices 110, access points 116 and radio node 118 can include (or can be included within) any electronic devices with the networking subsystems that enable electronic devices 110, access points 116 and radio node 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, base station 108, electronic devices 110, access points 116, radio node 118 and/or computer system 130 may wired or wirelessly communicate while: transmitting access requests and receiving access responses on wired or wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio node 118 and electronic devices 110. For example, radio 124-1 in access point 116-1 may transmit information (such as one or more packets or frames) using wireless signals 126. These wireless signals are received by radio 124-2 in electronic device 110-1. This may allow access point 116-1 to communicate information to other access points 116 and/or electronic devices 110. Note that wireless signals 126 may convey one or more packets or frames.

In the described embodiments, processing a packet or a frame in one or more electronic devices in electronic devices 110, access points 116, radio node 118 and/or computer system 130 may include: receiving the wireless or electrical signals with the packet or the frame; decoding/extracting the packet or the frame from the received wireless or electrical signals to acquire the packet or the frame; and processing the packet or the frame to determine information contained in the payload of the packet or the frame.

Note that the wired and/or wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

While FIG. 1 illustrates computer system 130 at a particular location, in other embodiments at least a portion of computer system 130 is implemented at more than one location. Thus, in some embodiments, computer system 130 is implemented in a centralized manner, while in other embodiments at least a portion of computer system 130 is implemented in a distributed manner.

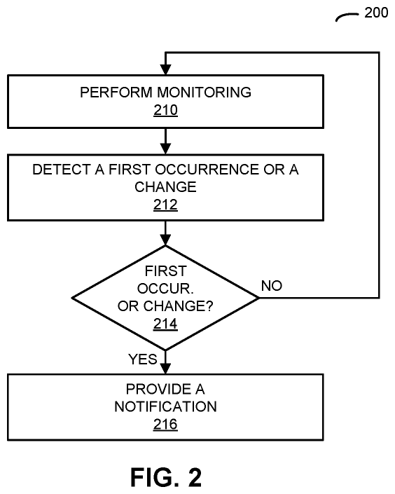

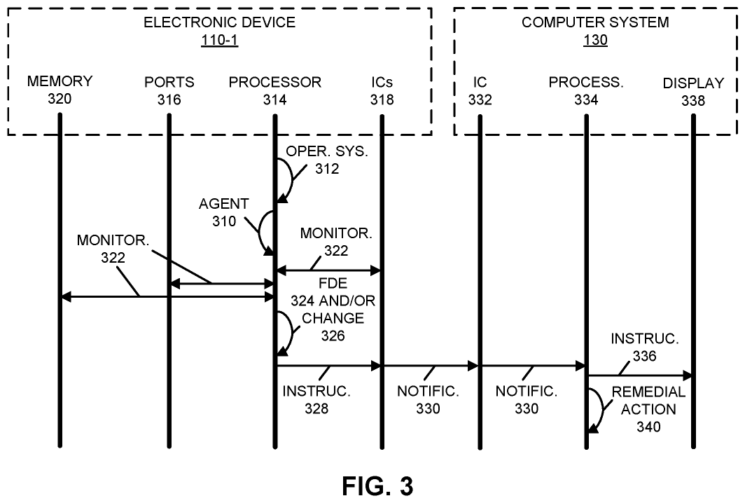

As discussed previously, detecting intrusion and/or malicious events in a computer system or a network is often difficult. Moreover, as described further below with reference to FIGS. 2-3, in order to address these challenges, electronic devices 110 and/or computer system 130 may perform the security techniques. Notably, agents executing in environments (such as operating systems) of electronic devices 110 may monitor and/or detect access attempts via a port (e.g., via a USB interface or another communication interface), software changes (e.g., to an operating system, a DLL, etc.), changes to stored information, first detection of a new electronic device, etc.

In some embodiments, analysis of the monitored information may be performed by a given agent executing on, e.g., electronic device 110-1 (such as to detect the changes and/or in order to perform the first detection). Next, the given agent may provide a notification of the detected changes and/or the first detection to computer system 130. After receiving the notification, computer system 130 may perform a remedial action, such as: presenting the notification to a network operator or administrator (e.g., on a display, via an alert or a message, etc.); isolating an effected electronic device(s) (such as disconnecting or disabling communication links with the effected electronic device(s), etc.); reverting to a previous state or configuration (such as by providing instructions to the effected electronic device(s); restoring a previous version of software or an operating system; and/or another type of remedial action. Moreover, computer system 130 may aggregated and store the information, data and/or notifications received from the agents for additional analysis and/or record keeping.

While the preceding discussion illustrated the security techniques with analysis performed by the given agent, in other embodiments at least a portion of the analysis may be performed by computer system 130. Thus, information or data collected by the given agent may be assessed and/or analyzed to determine additional information, and this assessment and/or analysis may, at least in part, be performed locally (e.g., by the given agent), remotely (e.g., by computer system 130), or jointly by the given agent on electronic device 110-1 and/or computer system 130. For example, after receiving the information specifying the collected data or information, computer system 130 may perform at least a portion of the assessment and/or analysis prior to performing any associated remedial action. Note that the communication among electronic devices 110 and/or computer system 130 may be secure (e.g., encrypted and/or via a tunnel).

In some embodiments, the assessment and/or analysis of the information or the data may be performed using an analysis model that is pretrained or predetermined using a machine-learning technique (such as a supervised learning technique, an unsupervised learning technique, e.g., a clustering technique, and/or a neural network) and a training dataset. For example, the analysis model may include a classifier or a regression model that was trained using: a support vector machine technique, a classification and regression tree technique, logistic regression, LASSO, linear regression, a neural network technique (such as a convolutional neural network technique, an autoencoder neural network or another type of neural network technique) and/or another linear or nonlinear supervised-learning technique. The analysis model may use information or data as inputs, and may output one or more detected changes, one or more first-detection events and/or one or more notifications. Note that computer system 130 may dynamically retrain a given analysis model based at least in part on updates to the training dataset (such as using aggregated or collected information or data, notifications, etc.), and then may optionally provide an updated analysis model to electronic devices 110.

In these ways, the security techniques may facilitate improved real-world monitoring and detection of changes and/or first-detection events in a scalable manner and with reduced or eliminated false-positive detections. These capabilities may facilitate accurate and timely remedial action. Consequently, the security techniques may improve security and user satisfaction, and may enhance business activity and trust.

While the preceding discussion illustrated the security techniques with real-time monitoring or detection and selective remedial actions, in other embodiments computer system 130 may perform a retrospective assessment and/or analysis of stored data and information.

We now describe embodiments of the method. FIG. 2 presents a flow diagram illustrating an example of a method 200 for providing a notification, which may be performed by an electronic device (such as electronic device 110-1 in FIG. 1), such as agent executing on or in an environment of the electronic device. During operation, the electronic device may perform monitoring (operation 210). Then, based at least in part on information or data obtained in the monitoring (operation 210), the electronic device may detect a first occurrence (operation 212), e.g., of a second electronic device accessing the electronic device, e.g., using: a communication protocol (such as USB) via an interface circuit, where the second electronic device has not previously accessed the electronic device using the communication protocol via the interface circuit. Alternatively or additionally, based at least in part on information or data obtained in the monitoring (operation 210), the electronic device may detect a change (operation 212), such as: detecting a change to an operating system or a BIOS driver of the electronic device while program instructions were deactivated or were not executed by a processor in the electronic device, and subsequent second change to stored information that corresponds to the runtime of the electronic device; detecting a change to stored information; and/or detecting a difference between information computed based at least in part associated with a stored DLL and predetermined information associated with the DLL. When the electronic device detects the first occurrence or the change (operation 214), the electronic device may provide, addressed to a computer, the notification (operation 216) indicating: the first occurrence, the detected change and/or the detected second change, or the detected difference. Otherwise, the electronic device may continue the monitoring (operation 210).

In some embodiments of method 200, there may be additional or fewer operations. Furthermore, the order of the operations may be changed, and/or two or more operations may be combined into a single operation.

Embodiments of the security techniques are further illustrated in FIG. 3, which presents a drawing illustrating an example of communication among components in electronic device 110-1 and computer system 130. In FIG. 3, an agent 312 executed in an environment of operating system 310 by processor 314 in electronic device 110-1 may monitor 322 ports 316, interface circuits (ICs) 318 in electronic device 110-1 and/or software stored in memory 320 in electronic device 110-1. Then, agent 312 may analyze the monitored information and data to detect a change 324 and/or a first-detection event (FDE) 326 Next, agent 312 may instruct 328 one of interface circuits 318 to provide a notification 330 to computer system 130.

After receiving notification 330, an interface circuit 332 in computer system 130 may provide notification 330 to processor 334 in computer system 130. Then, processor 334 may provide notification 330 to a network operator or administrator. For example, processor 334 may instruct 336 a display 338 in computer system 130 to display notification 330, such as in a user interface. In some embodiments, based at least in part on notification 330, processor 334 may selectively perform a remedial action 340.

While FIG. 3 illustrates communication between components using unidirectional or bidirectional communication with lines having single arrows or double arrows, in general the communication in a given operation in this figure may involve unidirectional or bidirectional communication.

We now further describe the security techniques. Agents may work in real-time to dynamically perform on-the-spot or real-time analysis of activity and collect data (either centrally and/or in a distributed manner) from layers of hardware, software, user activity, and/or network connections, including the internal and external subnets of an organization (such as multi DMZ or multi-demilitarized zones) and may establish the severity level of any particular event. (Note that a DMZ may be or may include a perimeter network that protects an internal local-area network or LAN of an organization from untrusted traffic.) Then, information may be fed to a dashboard in real-time, so that network and systems security team members can identify and resolve issues as they happen, while analysis of the endpoints leads to accurate issue identification.

A given agent may provide so-called ‘first detection’ (FD) of a potential anomaly in an electronic device or computer system the first time a change is detected or noticed (which, in the present disclosure, is referred to as a ‘potential anomaly’ or a ‘potential behavioral anomaly’). Thus, the given agent may provide a first detection alert of multiple subjects/processes found in the organization, thereby enabling the users to quickly analyze and act on (or perform a remedial action in response to) new threats or issues in the most effective way.

For example, the security techniques may provide first detection of USB, such as a USB device or a USB interface connection (and, more generally, a connection via an arbitrary type of interface). USB hardware properties (such as a media access control or MAC address) provide a soft unique identifier (UID). An electronic device or a computer system may handle file transition back and forth with this USB and/or may process USB communications. Properties of or associated with USB may include: a USB computer; USB dynamic change of internal file system; and/or Linux live (from Microsoft, Corp. of Redmond, Wash.). Note that Linux live includes the use of a USB device or USB drive as a runtime operating-system drive. Thus, a user can boot a computer system from the USB device or the USB drive and other drives may be data drives only. Moreover, the user can boot from the USB device or USB drive and then may mount the other drives and modify them without anyone knowing.

Furthermore, the security techniques may provide first detection (e.g., by an agent) of a new sharing session. Notably, the agent may detect a first file accessed by a user of the current machine (usually a file server) from a remote machine. In some embodiments, this capability may not require that the agent reside on or execute on the remote machine.

Additionally, the security techniques may provide first detection of a remote Internet Protocol (IP) address. Notably, the detection may occur after (or when) a first agent has marked an IP address as new for a specific or particular application. Note that the first agent may not the IP addresses of a Web browser. Instead, the first agent may focus on applications. This may allow the first agent to perform first detection of a web page, a website or a domain.

In some embodiments, the security techniques may provide first detection of a TCP listener port. This first detection may occur after (or when) a first agent has marked an opened listener port as new for a specific application.

Moreover, the security techniques may provide first detection of a process. This first detection may occur after (or when) a first agent has marked a process (e.g., by a checksum) as new on a machine. Note that a ‘new’ process may be identified as occurring for the first time because it did not previously have a checksum.

Furthermore, the security techniques may provide first detection of a change to a process version. This first detection may occur after (or when) a first agent has marked a new version change associated with a process in a machine. Note that this change may include a ‘good’ or normal change.

Additionally, the security techniques may provide first detection of process property anomalies. This first detection may occur after (or when) a first agent has marked a new abnormal change associated with a process in a machine. While the process may appear to be the same, it may not be the same as a normal version upgrade. For example, the checksum may be changed, but the file may be digitally unsigned (while a previous version of the file may have been digitally signed). Alternatively, the file name may be changed, etc. There may also have been a first detection using Yet Another Recursive/Ridiculous Acronym (YARA), which may perform malware detection using a signature.

In some embodiments, the security techniques may provide first detection of a driver. This first detection may occur after (or when) a first agent has identified or recalled a new driver installed on a machine or when there is a significant change.

Moreover, the security techniques may provide first detection of a service. This first detection may occur after (or when) a first agent has identified or recalled a new service was installed on a machine or when there is a significant change.

Furthermore, the security techniques may provide first detection of a service dynamic link library (DLL). This first detection may occur after (or when) a first agent has identified or recalled a new DLL that is assigned to or associated with a current service.

Additionally, the security techniques may provide first detection of software. This first detection may occur after (or when) a first agent has marked an installed software entry as new.

In some embodiments, the security techniques may provide first detection of a registry autorun. This first detection may occur after (or when) a first agent has identified additions or changes to autorun.

Moreover, the security techniques may provide first detection of a scheduler task. This first detection may occur after (or when) a first agent has identified a change to a scheduler task.

Furthermore, the security techniques may provide first detection of a hardware. This first detection may occur after (or when) a first agent has identified new or changed hardware.

Note that, in general, the first agent may detect or identify any new electronic device or change (e.g., hardware and/or software) in an electronic device.

Agents may work in real-time to dynamically perform on-the-spot analysis of activity and collect data from layers of hardware, software, user activity, and/or network connections, including the internal and external subnets of an organization (such as a multi DMZ) and may establish the severity level of any particular event. The collected information may then be fed to a dashboard in real-time, so that network and systems security team members can identify and resolve issues as they happen. Moreover, instant analysis of some or all endpoints may result in accurate issue identification and/or corrective or remedial action (such as providing an alert or notification, isolating a threat, disconnecting one or more affected electronic devices(s), etc.).

In some embodiments, there may be several computers (such as electronic devices 110) in a network. Each computer may include a preinstalled agent. This agent may see or detect anything and everything that occurs (in hardware and/or software) on the computer it is monitoring. The agent may provide the monitored information to a cloud-based computer system (such as computer system 130). However, in other embodiments, the server may be local instead of remote from the computer or servers. In the discussion that follows, a cloud-based computer system is used as an illustration.

The computers (C₁, Cₙ) may be any type of electronic device (e.g., a laptop, a desktop, a server, a handheld electronic device, a portable electronic device, a wearable electronic device, etc.). The cloud-based computer system may have two interfaces: one may be external, and one may be local. The agent may communicate with the cloud-based computer system through either local and/or external connection(s) if the client allows this behavior. As noted previously, each of the computers may have an agent installed and executing on it (such as agents al, an) with a unique identifier. The agents may monitor multiple activities (F₁-Fₙ), such as first detection of: USB, remote IP, TCP listener port, a process, a process version change, process property anomalies, driver(s), service(s), service DLL, software, registry autorun, a scheduler task, hardware, new sharing sessions, and/or a new BIOS version detection. These activities are described further below.

In general, a given agent may perform active monitoring. Thus, a given agent may be constantly operating and looking for changes, processes, and/or activities in a given computer. This agent may monitor processes, e.g., two times/second. Every process may be registered in internal memory and a stack may be created to identify which processes are from which location. Every new process that comes onto the computer may being checked to determine whether it is known or new. If one of these processes has never been run on the computer before, it may be categorized as new. This information may be sent to the cloud-based computer system (along with a hash, properties, the identifier of the agent and/or behavioral information). The cloud-based computer system may do the same. Notably, the cloud-based computer system may look at the list of processes to see if a given process is new to the organization. Once it is determined that the process is new, or is not part of the system list, it may be categorized it as a first detection: it is a new process and a first detection.

Once there is a first detection of a process, this process status can be monitored online in real-time (e.g., via the cloud-based computer system). By taking this approach, the system may be extremely effective and may be able to create corresponding information. Notably, each process identifier may be specific to a particular process and this process identifier may be created during the first detection of the new process. By having the agents to getting first-detection information from, e.g., the Internet, this information may only need to be received a few times. Consequently, there may not be a need to perform the detection on each of the computers. Instead, the detection may occur once in the cloud-based computer system, thereby saving time and money. This capability may allow the user, analyst or security manager to only look at or review first detections (which are sometimes referred to as ‘first-detection events’).

Every agent may be responsible for first detection within its own domain (e.g., it's computer or electronic device). A cloud-based computer system may run across and/or control the agents to ensure a given process is categorized appropriately/correctly.

Note that generating a unique identifier using a message-digest technique or MD5 (and, more generally, a cryptographic hash function) and/or a secure hash technique or SHA-1 is discussed further below.

In some embodiments, the security techniques (e.g., a given agent and/or the cloud-based computer system) may perform first detection of USB (or a connection via an interface or a port). Notably, an electronic device may be connected to a given computer using USB. In some embodiments, the electronic device may be a USB drive or a hard-disk drive (which, in general, are sometimes referred to as a ‘USB device’). In the registry, there may be information about, e.g., the USB drive or a hard-disk drive. Note that this information may be stored in several locations in the registry (e.g., in a distributed manner) based at least in part on a MAC address of the USB drive or the hard-disk drive.

In the case where a machine is being booted by a USB drive or a hard-disk drive having a different operating system, or when a USB drive or a hard-disk drive is taken out of the computer and being used on an external machine, the agent(s) may detect these two types of activities by monitoring the usage time of the hard-disk drives in the system. Note that a trusted platform module (TPM) can be worked around in hardware and, although this is often used to solve external boot issues, the disclosed security techniques offer another detection approach.

Moreover, the security techniques (e.g., a given agent and/or the cloud-based computer system) may perform first detection of a given driver using a randomized content signature. Notably, the location may be randomized and decided on the fly or dynamically by the agent within the drive (such as a USB drive or a hard-disk drive). The process may be as follows. A drive with external memory connected to a computer may have a hardware signature associated with metadata. When the hardware signature changes, the agent may know the drive has changed. However, the agent may not know what has changed. Therefore, when the drive is plugged in to the computer, its signature may be identified. Then, a randomized list of addresses (e.g., 32-bit addresses) may be collected or gathered. Furthermore, when the drive is plugged in, the agent may read what is at a given address. Next, the agent may create a signature (e.g., using SHA-1) of this information to create a unique signature. The agent may compare this signature to the signature gathered during a previous instance when the drive was plugged in. Additionally, the agent may gather or collect a final signature every time the drive is disconnected from the computer. When a device is improperly disconnected, a signature may be generated that creates what is identified as a ‘bad signature.’ Note that the signatures may be managed internally by the agent and/or by the cloud-based computer system.

During first detection of a USB device or drive, an agent may not only scans for a new USB device or drive, but it may also gather or collect a random selection of the hard-disk drive to confirm there are no changes to internal content. When the content is modified (e.g., contents are written to the disk, such as malware), the agent may take a new signature of this USB and its content. This may allow the agent to track changes on the USB device or drive, and each time a change is noted a new signature may be created. The alerts or notifications created in this way may signal that one or more changes have been made to a USB device or drive outside of a known state or configuration in the system.

For example, a USB device or drive may be connected to a computer. Moreover, content may be added/changed internal to the computer. Then, a signature may be created. When this USB device or drive is reconnected to this computer, no alert or notification may be given. However, when the content is altered on the USB device on a different second computer (which may be detected by another instance of the agent executing in an environment on the second computer), there may be an alert or a notification (and this alert or notification may lead to a remedial action). Note that this approach may uses super input/output (I/O) monitoring.

Another approach for a USB device may include storing and using the time of monitoring. For example, the agent and/or the cloud-based computer system may know the last time this USB hardware was monitored by the agent and/or the cloud-based computer system. In some embodiments, a normal versus an encrypted USB device may be used. Thus, if the USB device is not an encrypted USB device, it may trigger an alert or a notification with high importance or priority. Alternatively, if the USB device is encrypted, it may be considered legitimate (and, thus, may not trigger an alert or a notification, or may trigger an alert or a notification with lower or reduced importance or priority).

In some embodiments, the security techniques may use MD5 to generate a given identifier. In general, MD5 by itself may not be unique, given that it is possible to create two files with the same MD5. In order to create a more unique identity for each process, the agent and/or the cloud-based computer system may have multiple identities that are combined to create a completely unique, unrepeatable identity.

Moreover, in order to make the given identifier more unique, the agent and/or the cloud-based computer system may combine MD5 and SHA-1 (or another cryptographic hash or function). The probability of two separate files containing the same MD5 and SHA-1 value may be effectively zero. Note that the given identity may include: an MD5 value, an internal identifier, and/or a SHA-1 value. In general, there may be at least two identities for each track item, if not three or more.

In a new sharing session performed by an agent, the agent may internally monitor the activity and the sharing performed by, e.g., a Windows (from Microsoft Corp. of Redmond, Wash.) application programming interface (API). Depending on the processor threshold, the agent may determine how much of the processor cycles or capacity a given session consumes.

Note that, in the present disclosure, sharing may include Windows sharing (via a server message block or SMB). When a user requests access to a computer, the agent and/or the cloud-based computer system may look for situations where the computer is asking for permission to read or delete files on the computer or another computer.

As an example of a session, when the agent and/or the cloud-based computer system interacts with a file in any way, it can find out information about or associated with: a particular user, share requests, files being accessed, if the user is asking for an access or a delete (this may occur with or without the disclosed agent), etc. Moreover, the computer may have a predefined list of users within an organization. When this is the first time a user requests access to a computer, there may be an alert. Moreover, there may be a learning period (having a defined time period). For example, users that come in the next seven days may not initiate or trigger an alert or a notification. However, after seven days, there may be an alert for every new user/electronic device that is connecting to the computer. In general, first detection may occur per user on a given computer.

Note that some embodiments may include any kind of shared service (sharing of Windows, SMB, Windows sharing between computers, etc.). For example, one computer may access another computer, or a machine may access a computer, or vice versa.

Furthermore, the security techniques (e.g., a given agent and/or the cloud-based computer system) may perform first detection of a remote IP address. In general, any change in an IP address or string may be notified as a first detection, and first detection of an IP address may be per application. For companies or organizations that are completely disconnected from a network (such as the Internet), when someone tries to bypass this protection by connecting a mobile phone and creating a bridge to the Internet, the agent and/or the cloud-based computer system may identify the security risk. Consequently, the agent and/or the cloud-based computer system may perform a remedial action, such as disconnecting the network connection. Additionally, when there is an additional IP address added, the agent may send a notification to the cloud-based computer system. In some embodiments, a switch between an internal and an external network or location may signal or trigger an alert or a notification. For example, when a user takes their laptop or electronic device to a new location, an alert or a notification may be triggered. Note that for virtual private networks (VPNs) and/or proxies, the agent and/or the cloud-based computer system may monitor or see what the user is doing, as opposed to monitoring what the router is seeing.

Additionally, the security techniques (e.g., a given agent and/or the cloud-based computer system) may perform first detection of a TCP listener port. Notably, the agent may be able to see the communication direction the user went through and may have the ability to show a new TCP port is being opened (e.g., 8004). When another port opens, there may be an alert or a notification. For a first detection TCP listen port, there may be at least two types of alerts or notifications: a new alert; or a first detection alert.

In any organization (such as a large one), it may be ideal to know which application is open and on which port. For example, a network operator or administrator may see that application X is open and is supposed to be opened on port 8004. Moreover, the network operator or administrator can see it is open on a different port on different machines (e.g., port 8006 instead of port 8004). In this way, the agent and/or the cloud-based computer system may shed light on which ports are open for a given application (e.g., 99% of machines have application X open on port 8004 and 1% have it open on port 8006). By tracking this information, the agent and/or the cloud-based computer system can detect suspicious traffic. Notably, the agent and/or the cloud-based computer system may detect suspicious traffic by analyzing the last connections to see how many ports a user has on an IP address. This may allow IP address scanner detection to be detected (e.g., when users are being accessed from several ports, it may indicate an IP address scanner).

For example, the agent and/or the cloud-based computer system may have an IP address scanner that monitors a new port coming from a machine on a per-application basis. Alternatively or additionally, the IP address scanner may monitor a listener port (where someone from outside an organization can connect). When ports are opened within an organization, there is little concern. The IP address scanner may scan ports on the local network to identify different ports to go to and may scans IP addresses outside of a user's machine. Moreover, the IP address scanner may have a learning period, so that normal ports can be identified and recorded. This may allow or enable detection and alerting a network operator or administrator of newly opened ports. In some embodiments, the IP address scanner may detect suspicious traffic when there are more than 20 new IP connections/minute (which may be a first-detection event).

In some embodiments, the security techniques (e.g., a given agent and/or the cloud-based computer system) may perform first detection of a process. Notably, the first detection of the process may be associated with memory or virtual memory. For example, the first detection of the process may occur as follows. The agent may monitor running or executing processes in a machine (e.g., 2x/second). Then, the agent may analyze a process to see where it is running and other properties (e.g., what is stored at a location on a hard-disk drive), such as based at least in part on an identifier of the process (which may, at least in part, be determined using a cryptographic hash, such as MD5). Note that, in contrast with existing approaches, the security techniques may perform a comparison of what is on a hard-disk drive and what is in/on memory. Notably, the agent may access the hard-disk drive once and may see what is in memory. When the agent and/or the computer system sees something new to the memory, the agent and/or the computer system may check to see if it is in the same location and if it has the same name. Moreover, when there is a second application or program that it is not running, the agent and/or the computer system may go back again to perform a checksum (or another metric corresponding to the process) to see if the application was replaced. Furthermore, when the application stays in the memory, it may be unlikely that the application can be replaced because it is still running. This approach may reduce the need for comparisons and thus may improve the system performance.

The first detection of the process may differentiate between a user and a superuser (or a user with access privileges that are not limited or restricted). Moreover, the agent and/or the computer system may check (again) every property that is changed and may create a process identifier. The process, therefore, may be uniquely identified based at least in part on multiple properties.

Moreover, when a new process running on a computer is discovered, the agent may send an alert or a notification with an identifier of the process to the cloud-based computer system. The cloud-based computer system may search for this identifier in a look-up table (or data structure) to see if it is running on the computer. When a user in the organization has the exact same process identifier (in general, the same process may have the same MD5, but will have different properties), an alert or a notification may occur in the cloud-based computer system that indicates that this is ‘not a new first detection of this process, but it is a new first detection of an anomaly.’

In the same computer but for process with the same name and different MD5 value, and which is not a new version, another type of alert or notification may occur. For example, the alert or the notification may include an information alert with a new version (e.g., a change of the original name to the name when the process was compiled).

In general, first detection may be related to these and other types of alerts (e.g., anomaly, new version, etc.). When the detection is performed by a new agent or new cloud-based computer system, these events may be instances of first detection.

Moreover, the security techniques (e.g., a given agent and/or the cloud-based computer system) may perform first detection of a changed process version. Notably, a new process or first detection of a process may indicate that there is a new potential process coming. The new process may be associated with three types of new processes: a brand new process; a new version of a process (e.g., the agent and/or the cloud-based computer system may see the same properties of the file, such as a name, a vendor, etc., but it may appear to be a new version and the MD5 value or identifier and the version may change); and a new process property anomaly (e.g., the version may be the same, but the MD5 value or identifier may have changed, which indicates that something has changed within the file). The agent and/or the cloud-based computer system may have the ability to look at the different types of new processes together. Alternatively, the agent and/or the cloud-based computer system may review each type of new process event individually. Note that while these three types of new process events may be tracked by the agent and/or the cloud-based computer system they may categorized separate types of first-detection events.

Furthermore, the security techniques (e.g., a given agent and/or the cloud-based computer system) may perform first detection of process property anomalies. Notably, first detection of a process property anomaly may occur as follows. The agent may read the header and the MD5 value, and may check the properties (such as the properties that can be gathered from the operating system, such as Windows). The agent and/or the cloud-based computer system may not have a version update. Instead, other properties may have changed (e.g., a name change). This may result in a property anomaly. Note that a name change may indicate the same process. Thus, this is not a first detection, but is a changed name of the process. When the same process is changed from a signed to an unsigned version, the agent and/or the cloud-based computer system may report a more-interesting anomaly that is classified as having a higher risk level or priority.

Note that name change may include a change to metadata properties in the header. Notably, the header structure of a process may have many properties that can be checked. While only some of these properties may be monitored by the operating system, the agent may use them as part of the process identity signature.

Additionally, the security techniques (e.g., a given agent and/or the cloud-based computer system) may perform first detection of a driver. The first detection of a driver may be based at least in part on memory and an environment of the operating system. For example, the first detection of a driver may be based at least in part on a file or a group of files. A change in a process (such as a name, an MD5 value, a version or other changes in the driver) may be detected. Notably, the agent and/or the cloud-based computer system may show or present the unit name, the system name, a file path, a product name, a reason (e.g., a first detection of a new driver, a driver checksum, a property change), etc.

In some embodiments, the security techniques (e.g., a given agent and/or the cloud-based computer system) may perform first detection of a service. Note that a service may include the operating system (such as Windows) and may have a vector or an automatic link to: a process, a special process for running applications or automatic applications, and/or background processes. However, these may not be user processes. Instead, they may be mostly automatic processes under Windows control. For example, a GPU may have a service process on Windows that is responsible for keeping it alive or active at all times. A checksum may be run by the agent and/or the computer system to detect changes to the service. Therefore, first detection of a process may identify a change of a service. Note that a service may be similar to a driver, which is run by the operating system. Alternatively or additionally, a service may include a process. For example, a service may be a vector or a process, but it may be run as a service under Windows (e.g., an automatic process).

Moreover, the security techniques (e.g., a given agent and/or the cloud-based computer system) may perform first detection of a DLL. Notably, DLLs may run inside a process and may be dynamically accessed by the process. Content of a DLL file may be changed and may cause the running process to do things it should not. The existing approach for addressing this is to provide a DLL signature and to check it. However, in the disclosed security techniques, the agent and/or the cloud-based computer system may need to have a per-module or per-DLL signature, thereby allowing for changes that are legal (if possible) and to be able to catch malicious changes to a DLL on the fly or dynamically.

The DLLs in a computer may be divided into two sets. One set may include service DLLs and the other set may include some or all of the other or the remaining DLLs (which are not service DLLs). The service DLLs may be monitored by the agent via monitoring process announcements, such as which DLL it needs during runtime and via the operating system, while the other DLLs may be monitored on use by a process and once across the computer or a computer system. For example, when two processes are using the same DLL at the same time, the agent and/or the cloud-based computer system may assess the DLL once, instead of twice.

One of the concerns handled in the security techniques is that DLLs can be partially changed, e.g., not the entire file, but a subset of the functionality in the DLL could be changed without impacting the MD5 value of the entire file. As in other embodiments, the disclosed security techniques may use a combination of MD5 and SHA-1 signatures of every part of the DLL that can be downloaded into a process at runtime.

The monitoring of the service DLLs may be performed by connecting a process to the system DLLs and exercising each of them (which may require the agent and/or the cloud-based computer system to download the DLL modules that the process is invoking). When this DLL module is downloaded, the process can get its signature and verify it. This verification cycle may occur, e.g., 100-200 times per second.

Furthermore, the security techniques (e.g., a given agent and/or the cloud-based computer system) may perform first detection of software. For first detection of software, when an application is installed in the operating system (such as Windows), the agent and/or the computer system may gather information from a Windows inventory. When the agent and/or the computer system identifies a new record of installation of a new application with information (e.g., vendor information), the agent and/or the computer system may note that it is a new installation.

Additionally, the security techniques (e.g., a given agent and/or the cloud-based computer system) may perform first detection of registry autorun. Notably, similar to first detection of services, the agent and/or the cloud-based computer system may register autoruns, e.g., every new entry into the autorun queue, may be checked and, when there is a new entry, the agent and/or the cloud-based computer system may flag it.

In some embodiments, the security techniques (e.g., a given agent and/or the cloud-based computer system) may perform first detection of a scheduler task. Notably, the agent and/or the cloud-based computer system may identify a scheduler task from Windows tasks (which is typically in a different location than autoruns). These tasks may include some or all of the tasks for basic Windows components.

Moreover, the security techniques (e.g., a given agent and/or the cloud-based computer system) may perform first detection of hardware. Notably, the agent and/or the cloud-based computer system may detect the introduction of new hardware to the computer (e.g., a hard-disk drive, a keyboard/mouse, motherboards, a processor, a change on motherboard, BIOS changes, etc.). In some embodiments, the runtime of a driver may be monitored to demonstrate the use of the computer while the agent is not present. This may indicate potential illegal use.

Furthermore, the security techniques (e.g., a given agent and/or the cloud-based computer system) may perform first detection of a new BIOS or operating-system version. When first detection of new malicious activity for the BIOS occurs, the agent and/or the cloud-based computer system may classify it as new. For example, in general a new BIOS version may be downloaded on every new machine. Additionally, the agent and/or the cloud-based computer system may be able to detect versions and timestamps to identify cases where the BIOS was modified without a change to the version. In some embodiments, there may not be alerts on changes to the BIOS, only to the name and version of the BIOS (which may be sufficient). For example, source information can be used by the agent and/or the cloud-based computer system, such as tracking of the run hours of a hard-disk drive (such as for X hours the hard-disk drive was running).

We now describe embodiments of an electronic device, which may perform at least some of the operations in the security techniques. FIG. 4 presents a block diagram illustrating an example of an electronic device 400, e.g., one of electronic devices 110, access points 116, radio node 118, switch 128, and/or a computer or server in computer system 130, in accordance with some embodiments. For example, electronic device 400 may include: processing subsystem 410, memory subsystem 412, and networking subsystem 414. Processing subsystem 410 includes one or more devices configured to perform computational operations. For example, processing subsystem 410 can include one or more microprocessors, ASICs, microcontrollers, programmable-logic devices, GPUs and/or one or more DSPs. Note that a given component in processing subsystem 410 are sometimes referred to as a ‘computation device’.

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory. In some embodiments, instructions for processing subsystem 410 in memory subsystem 412 include: program instructions or sets of instructions (such as program instructions 422 or operating system 424), which may be executed by processing subsystem 410. Note that the one or more computer programs or program instructions may constitute a computer-program mechanism. Moreover, instructions in the various program instructions in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more nodes, such as antenna nodes 408, e.g., a metal pad or a connector, which can be coupled to the one or more antennas 420, or nodes 406, which can be coupled to a wired or optical connection or link. Thus, electronic device 400 may or may not include the one or more antennas 420. Note that the one or more nodes 406 and/or antenna nodes 408 may constitute input(s) to and/or output(s) from electronic device 400.) For example, networking subsystem 414 can include a Bluetooth™ networking system, a cellular networking system (e.g., a 3G/4G/5G network such as UMTS, LTE, etc.), a USB networking system, a networking system based on the standards described in IEEE 802.11 (e.g., a Wi-Fi® networking system), an Ethernet networking system, and/or another networking system.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 400 may use the mechanisms in networking subsystem 414 for performing simple wireless communication between electronic devices, e.g., transmitting advertising or beacon frames and/or scanning for advertising frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc. Moreover, electronic device 400 may include a user-interface subsystem 430, such as: a mouse, a keyboard, a trackpad, a stylus, a voice-recognition interface, and/or another human-machine interface.

Electronic device 400 can be (or can be included in) any electronic device with at least one network interface. For example, electronic device 400 can be (or can be included in): a desktop computer, a laptop computer, a subnotebook/netbook, a server, a supercomputer, a tablet computer, a smartphone, a smartwatch, a cellular telephone, a consumer-electronic device, a portable computing device, communication equipment, a monitoring device and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments program instructions 422 are included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 414 and/or electronic device 400. The integrated circuit may include hardware and/or software mechanisms that are used for transmitting signals from electronic device 400 and receiving signals at electronic device 400 from other electronic devices. Aside from the mechanisms herein described, radios are generally known in the art and hence are not described in detail. In general, networking subsystem 414 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the security techniques may be implemented using program instructions 422, operating system 424 (such as a driver for interface circuit 418) or in firmware in interface circuit 418. Thus, the security techniques may be implemented at runtime of program instructions 422. Alternatively or additionally, at least some of the operations in the security techniques may be implemented in a physical layer, such as hardware in interface circuit 418.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the security techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a second electronic device and a computer;
a processor coupled to the interface circuit;
memory, coupled to the processor, configured to store program instructions, wherein, when executed by the computation device, the program instructions cause the electronic device to perform operations comprising:
detecting a first occurrence of the second electronic device accessing the electronic device using a communication protocol via the interface circuit, wherein the second electronic device has not previously accessed the electronic device using the communication protocol via the interface circuit; and
providing, addressed to the computer, a notification indicating the first occurrence of access by the second electronic device.

2. The electronic device of claim 1, wherein the communication protocol comprises universal serial bus (USB).

3. The electronic device of claim 1, wherein the operations comprise:
detecting a second occurrence of the second electronic device accessing the electronic device using the communication protocol via the interface circuit, wherein the second occurrence occurs after the first occurrence; and
selectively providing, addressed to the computer and based at least in part on a change in a state of the second electronic device, a second notification indicating the second occurrence of access by the second electronic device.

4. The electronic device of claim 3, wherein the change in the state comprises a change in information stored in memory in the second electronic device.

5. The electronic device of claim 3, wherein the change in the state is relative to a previous state of the second electronic device.

6. The electronic device of claim 5, wherein the operations comprise determining the previous state of the second electronic device during the first occurrence of access by the second electronic device.

7. The electronic device of claim 1, wherein the detecting and the providing are performed by an agent that is preinstalled on the electronic device and that is configured to execute in an environment of the electronic device.

8. A non-transitory computer-readable storage medium for use in conjunction with the electronic device, the computer-readable storage medium configured to store program instructions that, when executed by the electronic device, cause the electronic device to perform operations comprising:
detecting a first occurrence of a second electronic device accessing the electronic device using a communication protocol via the interface circuit, wherein the second electronic device has not previously accessed the electronic device using the communication protocol via the interface circuit; and
providing, addressed to a computer, a notification indicating the first occurrence of access by the second electronic device.

9. The non-transitory computer-readable storage medium of claim 8, wherein the communication protocol comprises universal serial bus (USB).

10. The non-transitory computer-readable storage medium of claim 8, wherein the operations comprise:
detecting a second occurrence of the second electronic device accessing the electronic device using the communication protocol via the interface circuit, wherein the second occurrence occurs after the first occurrence; and
selectively providing, addressed to the computer and based at least in part on a change in a state of the second electronic device, a second notification indicating the second occurrence of access by the second electronic device.

11. The non-transitory computer-readable storage medium of claim 10, wherein the change in the state comprises a change in information stored in memory in the second electronic device.

12. The non-transitory computer-readable storage medium of claim 10, wherein the change in the state is relative to a previous state of the second electronic device.

13. The non-transitory computer-readable storage medium of claim 12, wherein the operations comprise determining the previous state of the second electronic device during the first occurrence of access by the second electronic device.

14. A method for providing a notification, comprising:
by an electronic device:
detecting a first occurrence of a second electronic device accessing the electronic device using a communication protocol via the interface circuit, wherein the second electronic device has not previously accessed the electronic device using the communication protocol via the interface circuit; and
providing, addressed to a computer, the notification indicating the first occurrence of access by the second electronic device.

15. The method of claim 14, wherein the communication protocol comprises universal serial bus (USB).

16. The method of claim 14, wherein the operations comprise:
detecting a second occurrence of the second electronic device accessing the electronic device using the communication protocol via the interface circuit, wherein the second occurrence occurs after the first occurrence; and
selectively providing, addressed to the computer and based at least in part on a change in a state of the second electronic device, a second notification indicating the second occurrence of access by the second electronic device.

17. The method of claim 16, wherein the change in the state comprises a change in information stored in memory in the second electronic device.

18. The method of claim 16, wherein the change in the state is relative to a previous state of the second electronic device.

19. The method of claim 18, wherein the operations comprise determining the previous state of the second electronic device during the first occurrence of access by the second electronic device.

20. The method of claim 14, wherein the detecting and the providing are performed by an agent that is preinstalled on the electronic device and that is configured to execute in an environment of the electronic device.
